(19) United States
(12) Patent Application Publication
(10) Pub. No.: US 2016/0350463 A1
(43) Pub. Date: Dec. 1, 2016

(54) Circuit Modeling With Partitioned Input Ranges

(71) Applicant: Avago Technologies General IP (Singapore) Pte. Ltd., Singapore (SG)

(72) Inventors: Nayak Ratnakar Aravind, Allentown, PA (US); Bruce A. Wilson, San Jose, CA (US)

(21) Appl. No.: 14/726,571

(22) Filed: May 31, 2015

(51) Int. Cl. G06F 17/50

(52) U.S. Cl. CPC G06F 17/5036

(57) ABSTRACT

A method of modeling an electronic circuit includes creating a model of the electronic circuit having at least one functional block with a linear sub-block and a non-linear sub-block, partitioning the linear sub-block into multiple partial input range linear sub-blocks, each adapted to primarily process a different range of input values, generating model parameters for each of the partial input range linear sub-blocks, simulating the electronic circuit based at least in part on the model parameters, and fabricating the electronic circuit.

### FIELD OF THE INVENTION

Various embodiments of the present invention provide systems and methods for modeling a hardware circuit.

### BACKGROUND

When designing an electronic circuit, the circuit design can be modeled before fabrication to verify correct functionality, and to optimize the design. Various circuit elements are represented by blocks in a circuit model, and a test input is applied to the circuit model to determine how the circuit design responds to the test input. However, it can be difficult to correctly match a model to a hardware circuit design over the expected operating range of input values and frequencies, particularly where the possible input values span a wide range. When the circuit model does not precisely match the circuit design, the resulting hardware circuit may not produce the desired results over every possible input value, or it may not be possible to achieve the best possible optimization of the hardware circuit by modeling with imprecise or imperfectly matched circuit models. In some cases, the circuit design options may even be limited by the available modeling techniques.

### BRIEF SUMMARY

Some embodiments of the present invention provide a method of modeling an electronic circuit including creating a model of the electronic circuit having at least one functional block with a linear sub-block and a non-linear sub-block, partitioning the linear sub-block into multiple partial input range linear sub-blocks, each adapted to primarily process a different range of input values, generating model parameters for each of the partial input range linear sub-blocks, simulating the electronic circuit based at least in part on the model parameters, and fabricating the electronic circuit.

The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phrases do not necessarily refer to the same embodiment. This summary provides only a general outline of some embodiments of the invention. Additional embodiments are disclosed in the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals may be used throughout several drawings to refer to similar components.

FIG. 1 depicts a first model of an example circuit which can be implemented with partitioned input ranges in accordance with some embodiments of the present invention;

FIG. 2 depicts a second model of an example circuit which can be implemented with partitioned input ranges in accordance with some embodiments of the present invention;

FIG. 3A depicts a finite impulse response filter that can be implemented with a partitioned input range in accordance with some embodiments of the present invention;

FIG. 3B depicts a model of a finite impulse response filter with partitioned input ranges in accordance with some embodiments of the present invention;

FIG. 4 depicts a model of a circuit element with partitioned input ranges in accordance with some embodiments of the present invention; and

FIG. 5 depicts a flow diagram showing a method for creating an electronic circuit including circuit modeling with partitioned input ranges in accordance with some embodiments of the present invention.

### DETAILED DESCRIPTION OF THE INVENTION

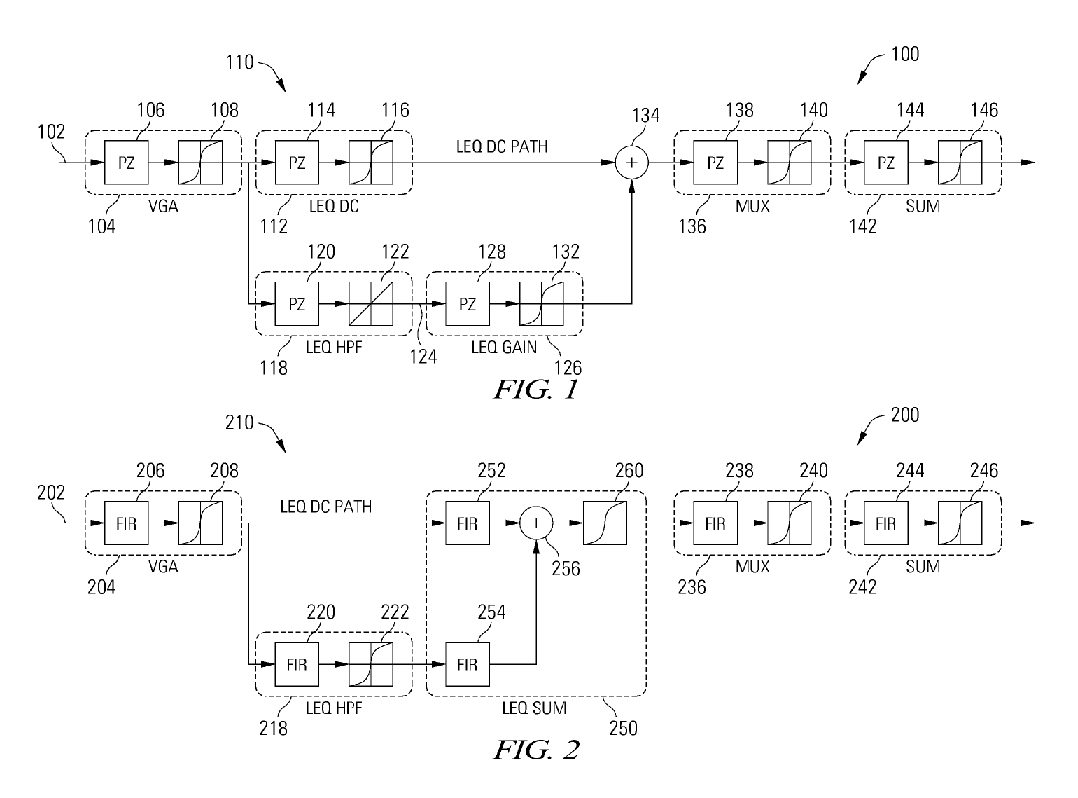

Various embodiments of the present invention provide systems and methods for modeling an electronic circuit with model blocks having partitioned input ranges. In some embodiments, the circuit model includes only observable nodes in the circuit, rather than modifying the netlist of the circuit design to make corresponding output nodes observable. Although model blocks for a finite impulse response filter are depicted and described herein in example embodiments of partitioning input ranges, it is important to note that the partitioning of input ranges disclosed herein is not limited to use with any particular type of circuit element. Furthermore, the observable node modeling disclosed herein is not limited to the example circuits depicted in the embodiments of FIGS. 1 and 2.

The model of a circuit can be generated based on the netlist of the circuit design in any suitable manner. For example, functional elements of a circuit can be represented by circuit models. To generate the parameters characterizing the model blocks, an analog simulation can be performed, sweeping the inputs through a range of frequencies and/or amplitudes to yield output vectors, then calculating parameters for model blocks based on the output vectors.

Turning to FIG. 1, an example circuit model 100 is depicted which can be modeled using partitioned input ranges in accordance with some embodiments of the invention. The example circuit model 100 corresponds with the analog front end of a read channel in a magnetic storage device, although circuit modeling with partitioned input ranges is not limited to use with any particular circuit or type of circuit. The analog front end performs functions such as amplification, equalization, DC offset correction, etc., on an analog signal received at an input 102. In some cases, the analog signal is derived from a read/write head assembly in a magnetic storage medium such as a hard disk drive. As the read/write head assembly is positioned adjacent a data track on a platter in the storage device, magnetic signals representing digital data written to the disk platter are sensed by the read/write head assembly as the disk platter is rotated. The sensed magnetic signals are provided as a continuous, minute analog signal representative of the magnetic data on the disk platter. In some other cases, the analog signal is derived from a receiver circuit that is operable to receive a signal from a transmission medium. Once the analog signal has been processed by the analog front end circuit, the resulting processed analog signal can be digitized to yield digital samples, digital data values represented by the digital samples can be detected, and error correction algorithms can be applied to the digital data values to detect and correct any errors that may have occurred during storage and reading.

Various elements of the example analog front end circuit are represented in the circuit model 100, including a variable gain amplifier block 104, a linear equalizer 110 which is modeled by a direct current (DC) portion and a high pass filter portion, a multiplexer block 136 and a sum block 142 used in a feedback equalizer. The DC portion of the linear equalizer 110 is modeled by a linear equalizer DC block 112. The higher frequency portion of the linear equalizer 110 is modeled by a linear equalizer high pass filter block 118 and a linear equalizer gain block 126. The outputs of the DC portion and the higher frequency portion of the linear equalizer 110 are combined in a combining block 134. Again, the circuit modeling with partitioned input ranges is not limited to any particular circuit or type of circuit, and the analog front end circuit modeled by the circuit model 100 is merely a non-limiting example, as are the circuit elements included in the analog front end circuit.

In this example, each model block in the circuit model 100 is represented by a linear sub-block and a non-linear sub-block or compression curve sub-block, which model the linear and non-linear behaviors of the circuit element represented by the block. The variable gain amplifier block 104 includes a linear sub-block 106 describing the linear transfer function of the variable gain amplifier, described by poles and zeros, and a non-linear sub-block 108 describing a compression curve for the variable gain amplifier, for example characterized by a polynomial, a hyperbolic tangent function, or any other function with a nonlinear relationship between the input and the output. Similarly, the linear equalizer DC block 112 includes a linear sub-block 114 and a non-linear sub-block 116. The linear equalizer high pass filter block 118 includes a linear sub-block 120 and a non-linear sub-block 122. The linear equalizer gain block 126 includes a linear sub-block 128 and a non-linear sub-block 132. The multiplexer block 136 includes a linear sub-block 138 and a non-linear sub-block 140. Finally, the sum block 142 includes a linear sub-block 144 and a non-linear sub-block 146.

Again, in some embodiments, the parameters of each sub-block are determined based on vectors obtained by sweeping the settings or input values of circuit elements. In one example embodiment, the length of the read channel is set to 0 and one-dimensional sweeps of all variable gain amplifier settings and linear equalizer settings are swept through their possible values to generate vectors representing output values, for example setting the linear equalizer boost to 0 and sweeping the variable gain amplifier from 0 to 15, then setting the variable gain amplifier to 8 and sweeping the linear equalizer from 0 to 31 to generate 94 vectors representing the input and output of each block over a range of conditions. In some embodiments, a DC sweep with varying input amplitudes and an AC sweep using an input sinusoid of varying frequency are performed to obtain the model for the linear and non-linear portions of a model block. The number of sweeps and the values included in the sweeps are not limited to the examples herein. In some other embodiments, a random-looking data pattern is applied to the input and the vector is based on the output of the model block for that input data pattern. The model parameters are then extracted from the vectors in any suitable manner, for example using a least squares fit for the sub-blocks using all relevant vectors from the analog simulator. Based upon the disclosure provided herein, one of ordinary skill in the art will recognize a variety of techniques for generating a circuit model and parameters for block and sub-blocks in the circuit model.

Turning now to FIG. 2, another example circuit model 200 is depicted for the analog front end circuit which can be modeled using partitioned input ranges in accordance with some embodiments of the invention. The example circuit model 200 of FIG. 2 also corresponds with the analog front end of a read channel in a magnetic storage device. In this circuit model 200, finite impulse response filters (FIRs) are used as the linear transfer function sub-blocks rather than the pole-zero linear transfer functions of FIG. 1. Linear transfer functions can be modeled using any suitable filter or other circuit element, such as, but not limited to, linear transfer functions described by poles and zeros, finite impulse response filters, infinite impulse response filters, etc.

In the circuit model 200 of FIG. 2, only observable circuit nodes are included. In order to precisely fit the parameters of the circuit blocks to the actual circuit, the input and output nodes of each model block should be observable. In the circuit model 100 of FIG. 1, the node 124 between the linear equalizer high pass filter block 118 and a linear equalizer gain block 126 is not directly observable, as they are implemented as one circuit element in some embodiments. In contrast, in the circuit model 200 of FIG. 2, the model blocks for the linear equalizer 210 have been rearranged, splitting up the linear sub-block and non-linear sub-block for the DC portion of the linear equalizer 210, and also splitting up the linear sub-block and non-linear sub-block for the linear equalizer gain block of the linear equalizer 210, replacing them with a linear equalizer sum block 250 having a separate linear sub-block 252, 254 for the DC path and the non-DC path, with their outputs combined in a combination circuit 256, and finally a single non-linear sub-block 260 for the linear equalizer sum block 250. The gain of the DC path and the non-DC path in the model of the linear equalizer 210 is thus described by separate linear transfer functions and a shared non-linear compression curve. This circuit model for the linear equalizer 210 uses only observable nodes in the circuit, so that the circuit model more closely fits the actual circuit and the parameters for the blocks are improved without needing to modify the netlist to make corresponding output nodes observable. Thus, in some embodiments of the invention, the circuit model uses only observable nodes in the actual circuit.

The remainder of the circuit model 200 in this embodiment matches that of the circuit model 100 of FIG. 1 for this example circuit. The variable gain amplifier block 204 includes a linear sub-block 206 describing the linear transfer function of the variable gain amplifier with a finite impulse response filter, and a non-linear sub-block 208 describing a compression curve for the variable gain amplifier, for example characterized by a polynomial. The multiplexer block 236 also includes a linear sub-block 238 and a non-linear sub-block 240. Finally, the sum block 242 includes a linear sub-block 244 and a non-linear sub-block 246.

Again, partitioning of input ranges in circuit model blocks can be applied to any circuit model, including the types of circuit models depicted in FIGS. 1 and 2.

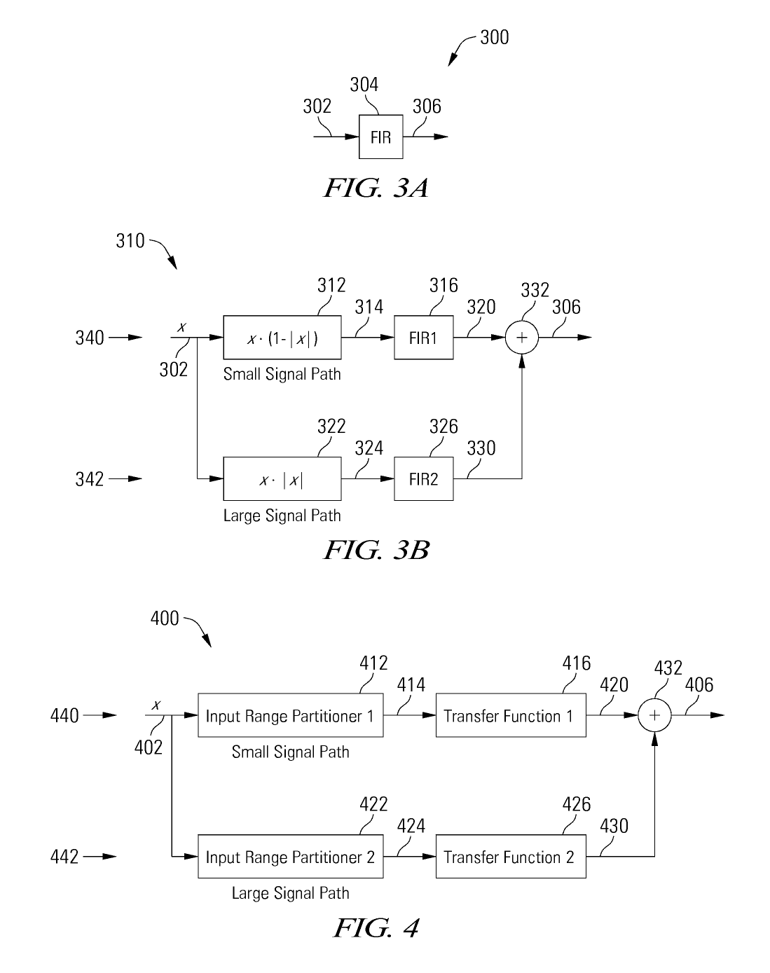

Turning now to FIG. 3A, an example model of a finite impulse response filter 304 that can be implemented with a partitioned input range is depicted in accordance with some embodiments of the present invention. Again, partitioning of input ranges in circuit model elements is not limited to use with any particular type of circuit element. The finite impulse response filter model 304 can be included in a circuit in any location desired, to model any circuit element as needed. For example, the finite impulse response filter 304 could be included in a circuit model to model the linear transfer function in a variable gain amplifier (e.g., 204) as in FIG. 2, or in the high pass filter (e.g., 218) of a linear equalizer (e.g., 210), etc. The parameters defining the characteristics of the finite impulse response filter model 304 can be determined based on an analog simulation of the circuit design in any suitable manner, as described above. Typically, the parameters of the finite impulse response filter model 304 would be selected so that the finite impulse response filter model 304 best fits the operation of the actual hardware circuit element as closely as possible to generate the actual output values at output 306 for the expected input values at input 302 during normal operation. The parameters might be adjusted toward a subset of the expected inputs to cause the model to display any design flaws being searched for. However, without partitioning the finite impulse response filter model 304 so that different parameters can be applied based on the input values, the finite impulse response filter model 304 typically will not precisely match the actual hardware circuit behavior over the entire range of possible input values.

Turning now to FIG. 3B, a model of a finite impulse response filter with partitioned input ranges 310 is depicted in accordance with some embodiments of the present invention. The possible range of input values is substantially divided in this embodiment into two ranges, with smaller input signal values being primarily processed in a small signal path 340 and larger input signal values being primarily processed in a large signal path 342.

Both the small signal path 340 and large signal path 342 include a finite impulse response filter model 316, 326. In some embodiments, the finite impulse response filter models 316, 326 are the same type of model element but with different parameters derived from the analog simulation vectors for different ranges of input values. Thus, each of the finite impulse response filter models 316, 326 can model the linear transfer function for the same circuit element, but can be adapted more closely to input values in different ranges. In other words, the parameters of the finite impulse response filter model 316 in the small signal path 340 are obtained based on the vector elements corresponding to relatively small input values, and the parameters of the finite impulse response filter model 326 in the large signal path 342 are obtained based on the vector elements corresponding to relatively large input values. This allows the least squares fit or other algorithm to better fit the parameters of the finite impulse response filter models 316, 326 to their corresponding portions of the response curves described by the vectors.

In the embodiment of FIG. 3B, the input signal x at model input 302 is partitioned by attenuation blocks 312, 322 into the small signal path 340 and large signal path 342. The outputs 320, 330 of the finite impulse response filter models 316, 326 in the small signal path 340 and large signal path 342 are combined in combination circuit 432 to yield the model output 406. In this embodiment, the input signal x is an analog input, and both the small signal path 340 and large signal path 342 receive a copy of the analog input, but the signals through the different paths are attenuated differently based on the value of the input signal at a given time. A very small signal is entirely or almost entirely attenuated as it passes through the large signal path 342, so that the output of the finite impulse response filter block 326 in the large signal path 342 will contribute a negligible amount in the overall output 306. A very large signal is entirely or almost entirely attenuated as it passes through the small signal path 340, so that the output of the finite impulse response filter block 316 in the small signal path 340 will contribute a negligible amount in the overall output 306.

In this embodiment, the attenuation blocks 312, 322 partition the input signal x by scaling their outputs 414, 424 based on the value of x. The attenuation block 312 in the small signal path 340 multiplies the input signal x by the quantity 1 minus the absolute value of x, outputting the product or result 314 of the multiplication. The attenuation block 322 in the large signal path 342 multiplies the input signal x by the absolute value of x, outputting the product or result 324 of the multiplication.

Output 314=x·(1−|x|) (Eq 1)

Output 324=x·(|x|) (Eq 2)

Partitioning the input signal x into multiple input ranges allows the model to apply different signal dynamics to small signal versus large signal portions of the incoming waveform. Having dual finite impulse response filter models in the partitioned model block captures much of the non-linear behavior seen in the analog simulation vectors, with the result that the compression curve sub-blocks in the model following the finite impulse response filters are closer to linear than in non-partitioned models.

Several numerical examples will be considered to illustrate the operation of the example embodiment depicted in FIG. 3B. In this embodiment, the absolute value of the input signal x ranges from 0 to 1, and the value of the input signal x ranges from −1 to 1. When the input signal x is closer to −1 or 1 than to 0, it is considered herein to have a large value, and when the input signal x is closer to 0, it is considered to have a small value.

If the input signal x has a very small value, 0.1, the attenuation block 312 in the small signal path 340 applies Equation 1 to yield 0.1·(1−|0.1|)=0.09, which is very close to x. The attenuation block 322 in the large signal path 342 applies Equation 2 to yield 0.1·|0.1|=0.01, which is a small fraction of x. Thus, the input signal x can be considered to primarily pass through and be processed by the small signal path 340, as it is heavily attenuated in the large signal path 342. Notably, the gain of the attenuation blocks 312, 322 is adapted so that the combined output 306 adds up to 100% of the signal that would be generated from a corresponding non-partitioned model element. That is, when x=0.1, the output 314 of attenuation block 312 is 0.09 and the output 324 of attenuation block 322 is the 0.01, for a total of 0.1, the value of x. Although a portion of the input signal x will be processed by finite impulse response filter model 316 in the small signal path 340 and another portion of the input signal x will be processed by finite impulse response filter model 326 in the large signal path 342, the partitioning does not scale the overall output 306 in this embodiment.

As another example, when the input signal x has a very large value, 0.9, the attenuation block 312 in the small signal path 340 applies Equation 1 to yield 0.9·(1−|0.9|)=0.09, which is a small fraction of x. The attenuation block 322 in the large signal path 342 applies Equation 2 to yield 0.9·|0.9|=0.81, which is very close to x. Thus, the input signal x can be considered to primarily pass through and be processed by the large signal path 342, as it is heavily attenuated in the small signal path 340.

Negative values of a sinusoidal analog input signal are similarly partitioned. When the input signal x has a very large negative value, −0.9, the attenuation block 312 in the small signal path 340 applies Equation 1 to yield −0.9·(1−|−0.9|)=−0.09, which is a small fraction of x. The attenuation block 322 in the large signal path 342 applies Equation 2 to yield −0.9·|−0.9|=−0.81, which is very close to x. Thus, the input signal x can be considered to primarily pass through and be processed by the large signal path 342, as it is heavily attenuated in the small signal path 340.

In this two-path embodiment, a moderate signal having a value or amplitude (e.g., 0.5) that is halfway between the setpoints (in this case, 0 and 1) distinguishing the small and large signals will pass through both small and large signal paths 340, 342 about equally, so that the outputs of both finite impulse response filter blocks 316, 326 will contribute to the overall output roughly equally.

The attenuation blocks can be adapted to different possible input ranges rather than the 0 to 1 range for the absolute value of input signal x in the embodiment of FIG. 3B, by scaling or normalizing the input signal before partitioning, by scaling the input signal in the attenuation blocks, by modifying the equation or algorithm applied in the attenuation blocks, or in any other suitable manner. Based upon the disclosure provided herein, one of ordinary skill in the art will recognize a variety of techniques for partitioning an analog signal into multiple paths based on where the analog signal lies in ranges of values.

The partitioning can use any algorithm or technique to split the input to different paths, or to substantially split the input to different paths, and is not limited to the algorithm applied in Equations 1 and 2. Furthermore, input values can be partitioned into more than the two ranges of FIG. 3B.

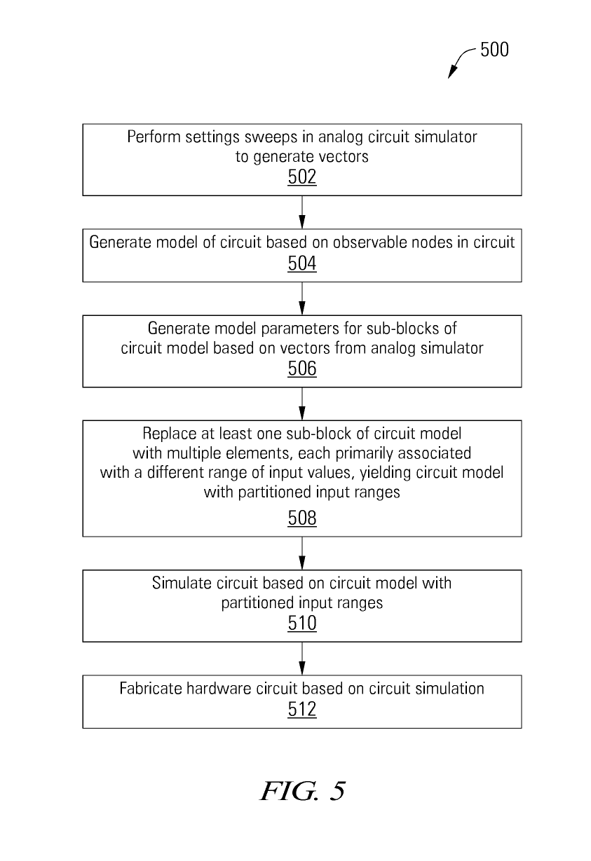

Again, partitioning of input ranges in circuit models is not limited to the finite impulse response filter model block of FIGS. 3A-3B. Turning to FIG. 4, a model 400 of a generalized circuit element with partitioned input ranges is depicted in accordance with some embodiments of the present invention. The input signal x at model input 402 is partitioned by partitioning blocks 412, 422 into a small signal path 440 and a large signal path 442, yielding partitioned input signals 414, 424. The input signal x can be partitioned in any suitable manner, such as, but not limited to, applying different attenuation or gain levels based on the value of the input signal x, comparators, or any other suitable manner. In some embodiments, the small signal path input range partitioner 412 is configured to output a product of the input signal multiplied by a difference between a maximum value of the input signal and an absolute value of the input signal, and the large signal path input range partitioner 422 is configured to output a product of the input signal multiplied by an absolute value of the input signal. Based upon the disclosure provided herein, one of ordinary skill in the art will recognize a variety of techniques for partitioning an analog signal into multiple paths based on where the analog signal lies in ranges of values.

The partitioned input signals 414, 424 are processed by transfer function blocks 416, 426, also referred to herein as partial input range sub-blocks, which apply transfer functions with different signal dynamics to small signal versus large signal portions of the incoming waveform, yielding transfer function outputs 420, 430. The transfer functions applied in the transfer function blocks 416, 426 can be the same type of transfer function with different parameters adapted from different portions of the analog simulator vectors, and can be any type of transfer function, such as, but not limited to, a linear transfer function implemented as a finite impulse response filter, an infinite impulse response filter, a filter described by poles and zeros, etc. A combination circuit 432 combines the transfer function outputs 420, 430 to yield the model output 406.

Turning now to FIG. 5, flow diagram 500 depicts a method for creating an electronic circuit including circuit modeling with partitioned input ranges in accordance with some embodiments of the present invention. Following flow diagram 500, settings sweeps are performed in an analog circuit simulator to generate vectors. (Block 502) In some embodiments, the settings sweeps are one-dimensional sweeps which vary values in one circuit element at a time to identify the outputs resulting from varying input values. In some embodiments, the circuit model includes only observable nodes in the circuit. (Block 504) Parameters for all the sub-blocks of the circuit model are generated based on the vectors from the analog simulator. (Block 506) This can be performed, for example, by performing a least squares fit algorithm on the relevant vectors from the analog simulator to obtain the parameters of, for example, a linear transfer function in the circuit model. At least one sub-block of the circuit model is partitioned according to input ranges, replacing the sub-block with multiple model elements, each primarily associated with a different range of input values, yielding a circuit model with partitioned input ranges. (Block 508) The circuit is simulated based on the circuit model with partitioned input ranges. (Block 510) The hardware circuit is fabricated based on the circuit design resulting from the circuit simulation using the circuit model with partitioned input ranges.

Circuit modeling with partitioned input ranges enables the model to identify artifacts in hardware circuit designs that can occur when the input signal is at the edges of the normal operating range, thereby providing accurate modeling over a wide range of inputs, rather than just at the middle of the operating range as in circuit modeling without partitioned input ranges. Rather than attempting to identify parameters for the linear and non-linear model components that work across the whole operating region, the operating region is partitioned into multiple sections. A different set of parameters is selected to model the different sections of the operating range, and the resulting models are combined in a way that activates different portions of the model based on what the input signal is doing. Circuit modeling with partitioned input ranges thus provides much better matching to actual circuit behavior by applying different signal dynamics to models for different portions of the incoming waveform. Furthermore, by better matching linear models to the non-linear behavior seen in the analog simulation vectors, the compression curves modeled by non-linear model elements are closer to linear, easing the task of the non-linear model elements as well.

In conclusion, the present invention provides novel apparatuses and methods for circuit modeling with partitioned input ranges. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method of modeling an electronic circuit, comprising:
creating a model of the electronic circuit having at least one functional block comprising a linear sub-block and a non-linear sub-block;
partitioning the linear sub-block into a plurality of partial input range linear sub-blocks, each adapted to primarily process a different range of input values;
generating model parameters for each of the partial input range linear sub-blocks;
simulating the electronic circuit based at least in part on the model parameters; and
fabricating the electronic circuit.

2. The method of claim 1, wherein the electronic circuit comprises an analog circuit, and wherein the different ranges of input values comprise different ranges of values of an analog signal at an input of the linear sub-block.

3. The method of claim 1, wherein the partial input range linear sub-blocks comprise a small signal path and a large signal path.

4. The method of claim 1, wherein the linear sub-block comprises a plurality of input range partitioning blocks configured to control a portion of an input signal allowed to enter each of the partial input range linear sub-blocks.

5. The method of claim 4, wherein one of the plurality of input range partitioning blocks is configured to output a product of the input signal multiplied by a difference between a maximum value of the input signal and an absolute value of the input signal.

6. The method of claim 4, wherein one of the plurality of input range partitioning blocks is configured to output a product of the input signal multiplied by an absolute value of the input signal.

7. The method of claim 1, wherein the model comprises only observable nodes in the electronic circuit.

8. The method of claim 7, wherein at least one of the at least one functional blocks comprises a plurality of linear sub-blocks, each associated with a path for a different input frequency, and a shared non-linear sub-block.

9. The method of claim 1, wherein the model parameters are generated by sweeping values in an analog simulation of the electronic circuit.

10. The method of claim 9, wherein the sweeping comprises one dimensional value sweeps.

11. The method of claim 9, wherein sweeping the values yields an output vector, and wherein generating the model parameters for each of the partial input range linear sub-blocks comprises applying a fitting algorithm to a portion of the output vector corresponding to a partial range of input values to the electronic circuit.

12. The method of claim 11, wherein the fitting algorithm comprises a least squares fit.

13. The method of claim 1, wherein the linear sub-block comprises a model of a finite impulse response filter.

14. An electronic circuit, comprising:
a plurality of functional blocks, each having at least one input and at least one output, wherein the plurality of functional blocks have been simulated using circuit blocks comprising a linear sub-block and a non-linear sub-block, wherein at least one of the linear sub-blocks is partitioned into a plurality of partial input range linear sub-blocks, each adapted to primarily process a different range of input values.

15. The electronic circuit of claim 14, wherein the electronic circuit comprises an analog circuit, and wherein the different ranges of input values comprise different ranges of values of an analog signal at an input of the linear sub-block.

16. The electronic circuit of claim 14, wherein the linear sub-block comprises a plurality of input range partitioning blocks configured to control a portion of an input signal allowed to enter each of the partial input range linear sub-blocks.

17. The electronic circuit of claim 16, wherein one of the plurality of input range partitioning blocks is configured to output a product of the input signal multiplied by a difference between a maximum value of the input signal and an absolute value of the input signal.

18. The electronic circuit of claim 16, wherein one of the plurality of input range partitioning blocks is configured to output a product of the input signal multiplied by an absolute value of the input signal.

19. The electronic circuit of claim 14, wherein an input and an output of each of the plurality of functional blocks are directly observable in the electronic circuit.

20. A system for modeling an analog circuit, comprising:
means for creating a model of the analog circuit having at least one functional block comprising a linear sub-block and a non-linear sub-block;
means for partitioning the linear sub-block into a plurality of partial input range linear sub-blocks, each adapted to primarily process a different range of input values; and
means for generating model parameters for each of the partial input range linear sub-blocks.
